(19) United States
(12) Patent Application Publication
(10) Pub. No.: US 2015/0100904 A1
(43) Pub. Date: Apr. 9, 2015

(54) Desktop Filter

(71) Applicant: Apple Inc., Cupertino, CA (US)

(72) Inventors: Imran A. Chaudhri, San Francisco, CA (US); Christopher Hynes, Mountain View, CA (US); Eric Steven Peyton, Lisle, IL (US); John O. Louch, San Luis Obispo, CA (US); Timothy Wayne Bumgarner, Sharpsburg, MD (US)

(21) Appl. No.: 14/512,908

(22) Filed: Oct. 13, 2014

Related U.S. Application Data
(63) Continuation of application No. 11/760,717, filed on Jun. 8, 2007, now abandoned.

(51) Int. Cl. G06F 3/0482; G06F 3/0484

(52) U.S. Cl. CPC G06F 3/0482; G06F 3/04847
USPC 715/763

(57) ABSTRACT

A desktop operable to display one or more system objects is modified using one or more filters, operable to modify the presentation of the one or more system objects.

### BACKGROUND

A graphical user interface allows a large number of graphical objects or items to be displayed on a display screen at the same time. Leading personal computer operating systems, such as Apple Mac OS®, provide user interfaces in which a number of visualizations of system objects, such as windows, system functions, alerts, visualization objects representative of files, peripherals, applications, and other representations of system objects can be displayed according to the needs of the user. Taskbars, menus, virtual buttons, a mouse, a keyboard, and other user interface elements provide mechanisms for accessing and/or activating the system objects corresponding to the displayed representations.

The graphical representations of system objects and access to the corresponding system objects and related functions should be presented in a manner that facilitates an intuitive user experience with the graphical user interface. The use of a large number of graphical representations simultaneously on a graphical user interface, however, can detract from an intuitive user experience where the graphical user interface becomes cluttered with too may graphical representations.

### SUMMARY

Disclosed herein is a method and system. In an implementation, the method includes providing a desktop, where the desktop is operable to display one or more system objects, and modifying the display of at least some of the one or more system objects on the desktop using a filter.

One or more of the following features may also be included. The system objects can include one or more desktop items, one or more stack items, and/or one or more file elements. Modifying the display of at least some of the one or more system objects using a filter can include modifying the location of at least some of the one or more system objects on the desktop, removing at least some of the one or more system objects from the desktop, grouping at least some of the one or more system objects together on the desktop, and/or stacking at least some of the one or more system objects together on the desktop.

Additionally, the desktop can include a three-dimensional desktop defining a depth aspect, which may include a viewing surface, a back surface disposed at a terminus of the depth aspect, and a floor surface extending from the back surface to the viewing surface. Modifying the display of at least some of the one or more system objects using a filter can include repositioning at least some of the one or more system objects on the three-dimensional desktop, moving the at least some of the one or more system objects from a first viewing surface, back surface, or floor surface to a second viewing surface, back surface, or floor surface.

According to another feature, the filter can include a panel operable to receive instructions for modifying the display of the at least some of the one or more system objects on the desktop. The instructions may modify the display of the at least some of the one or more system objects based on a system object type, a system object location, or a date associated with a system object, such as a date the object was created, a date the object was modified, a date the object was viewed, or a date the object was deleted. Additionally, the panel can display the at least some of the one or more system objects, and/or one or more user-selectable rules.

According to yet other features, the desktop can include one or more areas, and modifying the display of at least some of the one or more system objects on the desktop can include modifying the display of one or more system objects located in one of the one or more areas. The modification of the one or more system objects may be illustrated graphically, such as illustrating the movement of a system object from a first location on the desktop to a second location on the desktop, and/or deleting a system object. Furthermore, the one or more system objects can include one or more functional visualization objects. Additionally, the filtering of one or more system objects can occur automatically using one or more instructions, which may be stored.

These general and specific aspects may be implemented using a system, a method, or a computer program, or any combination of systems, methods, and computer programs.

### BRIEF DESCRIPTION OF THE DRAWINGS

Reference will now be made to the accompanying drawings, which are not necessarily drawn to scale, and wherein:

FIG. 1 is a block diagram of an example system that can be utilized to implement the systems and methods described herein.

FIG. 2 is a block diagram of an example user interface architecture.

FIG. 3 is a block diagram of an example user interface engine architecture.

FIG. 4 is block diagram of example system layer structure that can be utilized to implement the systems and methods described herein.

FIG. 5 is a block diagram of an example desktop environment including a desktop filter.

FIG. 6 is a block diagram of an example desktop environment illustrating desktop filtering using a desktop filter.

FIG. 7 is a block diagram of another example desktop environment illustrating desktop filtering using a desktop filter.

FIG. 8 is a block diagram of another example desktop environment illustrating desktop filtering using a desktop filter.

FIG. 9 is a block diagram of another example desktop environment illustrating desktop filtering using a desktop filter.

FIG. 10 is a block diagram of another example desktop environment including a desktop filter.

FIG. 11 is a block diagram of another example desktop environment illustrating desktop filtering using a desktop filter.

FIG. 12 is a block diagram of another example desktop environment including a desktop filter.

FIG. 13 is a block diagram of an example multidimensional desktop environment including a desktop filter.

FIG. 14 is a block diagram of an example multidimensional desktop environment illustrating desktop filtering using a desktop filter.

FIG. 15 is a flow diagram of an example process for modifying the display of one or more system objects on a desktop using a filter.

FIG. 16 is a flow diagram of an example process for using a filter to modifying the display of one or more system objects on a desktop.

### DETAILED DESCRIPTION

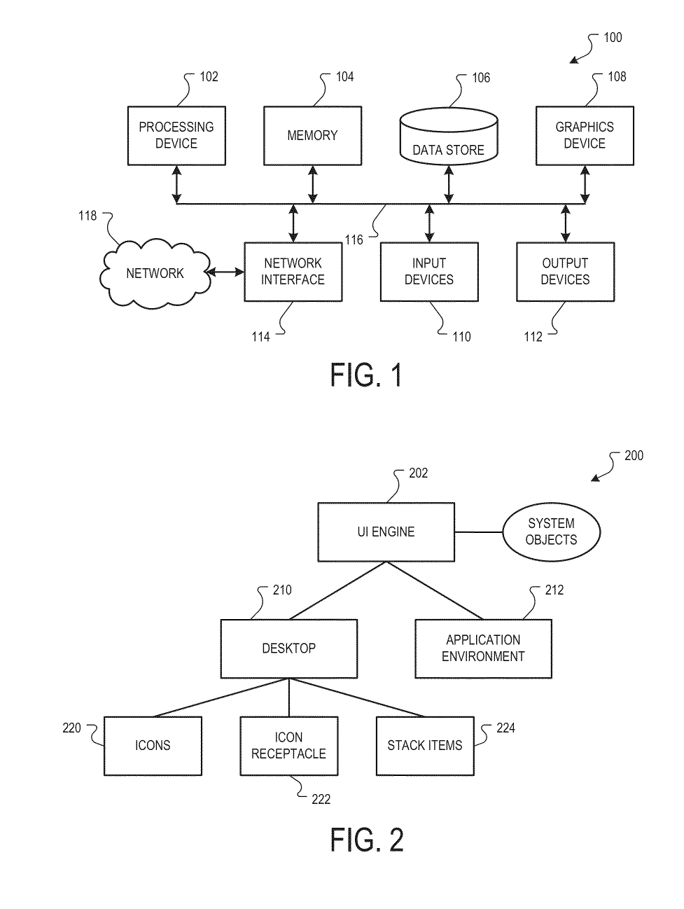

FIG. 1 is a block diagram of an example system 100 that can be utilized to implement the systems and methods described herein. The system 100 can, for example, be implemented in a computer device, such any one of the personal computer devices available from Apple Computer, Inc., or other electronic devices. Other example implementations can also video processing devices, multimedia processing devices, portable computing devices, portable communication devices, set top boxes, personal digital assistants, etc.

The example system 100 includes a processing device 102, a first data store 104, a second data store 106, a graphics device 108, input devices 110, output devices 112, and a network device 114. A bus system 116, such as a data bus and a motherboard, can be used to establish and control data communication between the components 102, 104, 106, 108, 110, 112 and 114. Other example system architectures, however, can also be used.

The processing device 102 can, for example, include one or more microprocessors. The first data store 104 can, for example, include a random access memory storage devices, such as a dynamic random access memory, or other types of computer-readable medium memory devices. The second data store 106 can, for example, include one or more hard drives, a flash memory, and/or a read only memory, or other types of computer-readable medium memory devices.

The graphics device 108 can, for example, include a video card, a graphics accelerator card, or display adapter and is configured is to generate and output images to a display device. In one implementation, the graphics device 108 can be realized in a dedicated hardware card connected to the bus system 116. In another implementation, the graphics device 108 can be realized in a graphics controller integrated into a chipset of the bus system 116. Other implementations can also be used.

Example input devices 110 can include a keyboard, a mouse, a stylus, a video camera, etc., and example output devices 112 can include a display device, an audio device, etc.

The network interface 114 can, for example, include a wired or wireless network device operable to communicate data to and from a network 118. The network 118 can includes one or more local are networks (LANs) or a wide area network (WAN), such as the Internet.

In an implementation, the system 100 includes instructions defining an operating system stored in the first data store 104 and/or the second data store 106. Example operating systems can include the MAC OS® X series operating system, the WINDOWS® based operating system, or other operating systems. Upon execution of the operating system instructions, access to various system objects is enabled. Example system objects include data files, applications, functions, windows, etc. To facilitate an intuitive user experience, the system 100 includes a graphical user interface that provides the user access to the various system objects and conveys information about the system 100 to the user in an intuitive manner.

FIG. 2 is a block diagram of an example user interface architecture 200. The user interface architecture 200 includes a user interface (UI) engine 202 that provides the user access to the various system objects 204 and conveys information about the system 100 to the user.

Upon execution, the UI engine 202 can cause the graphics device 108 to generate a graphical user interface on an output device 112, such as a display device. In one implementation, the graphical user interface can include a two dimensional desktop environment.

In another implementation, the graphical user interface can include a multidimensional desktop 210 and a multidimensional application environment 212 including x-, y- and z-axis aspects, e.g., a height, width and depth aspect. The x-, y- and z-axis aspects may define a three-dimensional environment, e.g., a “3D” or “2.5D” environment that includes a z-axis, e.g., depth, aspect. In an implementation, the multidimensional application environment can include an application environment distributed along a depth aspect. For example, a content frame, e.g., an application window, can be presented on a first surface, and control elements, e.g., toolbar commands, can be presented on a second surface.

In an implementation, the desktop 210 can include visualization objects 220, and optionally, a visualization object receptacle 222 and/or stack items 224. An example implementation of a visualization object receptacle 300 is the “Dock” user interface in the MAC OS® X Leopard operating system. Other implementations can also be used. In some implementations, the visualization objects 220, the visualization object receptacle 222, and the stack items 224 can be presented as two dimensional graphical objects or, in a pseudo-three dimensional (i.e., “2.5D”) or a three dimensional environment, as graphical objects have a depth aspect.

A visualization object 220 can, for example, be a visual representation of a system object. In some implementations, the visualization objects 220 are icons. Other visualization objects can also be used, e.g., alert notification windows, menu command bars, windows, or other visual representations of system objects.

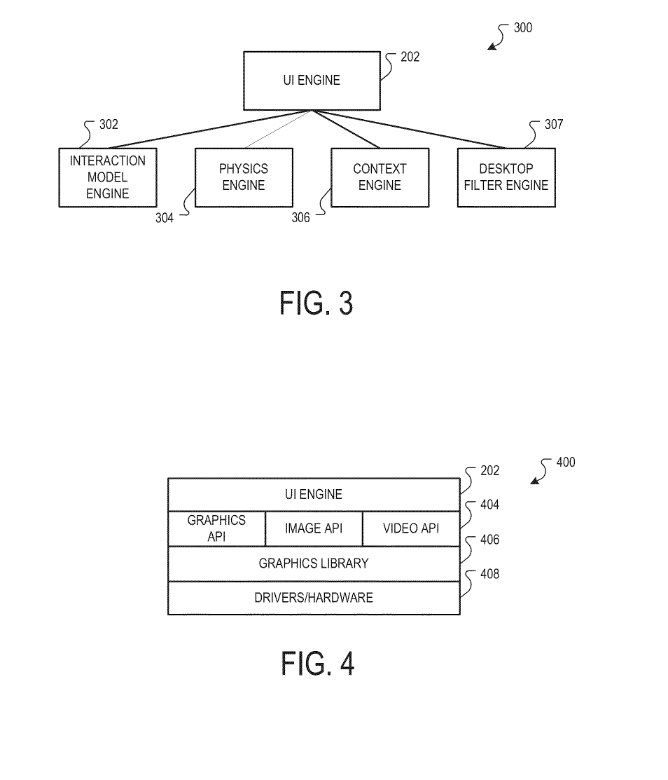

FIG. 3 is a block diagram of an example user interface engine architecture 300. The UI engine 202 can, for example, include an interaction and visualization model engine 302, a physics engine 304, and a context engine 306. Other engines can also be included.

In one implementation, the interaction and visualization model engine 302 can identify association characteristics of associated visualization objects, e.g., icons. The associated graphical elements can be collectively displayed, e.g., in an object stack, or can be distributed in a desktop/folder hierarchy in which only one visualization object is displayed. Based on the identified characteristic, the interaction and visualization model engine 302 can automatically select an interaction model and/or visualization mode that defines how the user may interact with and view the associated graphical elements.

In one implementation, the physics engine 304 can apply a physics aspect, such as Newtonian physics models based on mass, velocity, etc., to the visual representations of system objects, such as windows. In an implementation, the windows can be modeled as rigid bodies or non-rigid bodies. For example, placing a window on a surface next to adjacent windows can cause the adjacent windows to shift positions in response to a simulated disturbance from the window placement. The physics engine 304 can also effect motion of system objects, including windows, to permit movement of the system objects and other graphical functions, such as scaling of a window, making a window become transparent, and the like.

The context engine 306 can, for example, provide contextual control of a system objects based on a context. For example, windows can be defined according to a window type, and each window type may be subject to different rules for display, movement, and removal. Other contextual control can also be provided, such as contextual control based on a temporal context, or an execution context, and the like.

In an implementation, the desktop filter engine 307 is operable to apply one or more rules to a desktop and/or computing device, for instance, as a desktop environment including a graphical user interface, to modify the display of one or more system objects on the desktop. The one or more rules may be applied automatically, on command, or otherwise and can be configurable and/or established by a user via one or more desktop filters presented to the user via one or more graphical user interfaces, such as desktop filter panels.

FIG. 4 is block diagram of example system layers 400 that can be utilized to implement the systems and methods described herein. Other system layer implementations, however, can also be used.

In an implementation, a UI engine, such as the UI engine 202, operates an application level 402 and implements graphical functions and features available through an application program interface (API) layer 404. Example graphical functions and features include graphical processing, supported by a graphics API, image processing, support by an imaging API, and video processing, supported by a video API.

The API layer 404, in turn, interfaces with a graphics library layer 406. The graphics library layer 404 can, for example, be implemented as a software interface to graphics hardware, such as an implementation of the OpenGL specification. A driver/hardware layer 408 includes drivers and associated graphics hardware, such as a graphics card and associated drivers.

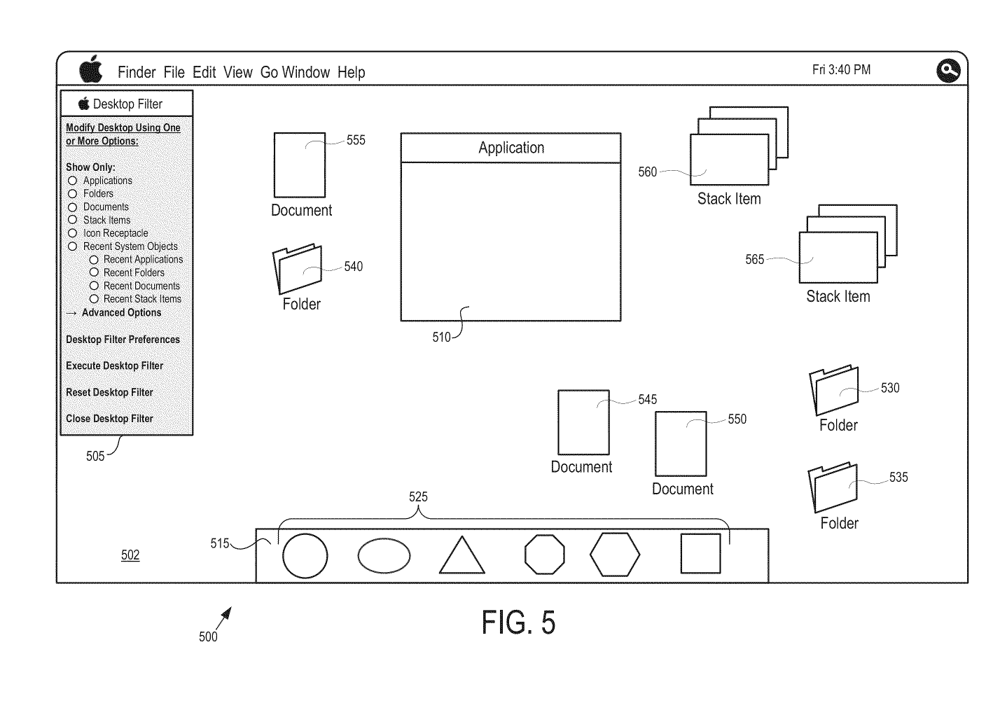

FIG. 5 is a block diagram of an example desktop environment 500. In an implementation, the desktop environment 500 provides a two dimensional viewing surface 502. The viewing surface 502 can include a visualization object receptacle 515, which is a system object that can include one or more visualization objects 525, e.g., icons. The visualization objects 525 can, for example, include graphical representations, e.g., icons, corresponding to one or more system objects, such as applications, documents, and functions. The viewing surface 502 can also include one or more other system objects separate from the visualization object receptacle 515, such as one or more folders 530, 535, 540, documents 545, 550, 555, stack items 560, 565, windows 510, and the like.

According to an implementation, each folder 530, 535, 540 can represent a storage receptacle for one or more files, applications, or additional system objects. Each window 505, 510 can represent an application, a message, alert or notification, and/or another system object. For instance, a window 510 can represent computer programs viewed and/or controlled by a user via the illustrative desktop environment, or an alert or notification, such as a download status window, a message alert window, or the like. Additionally, a document 545, 550, 555 may represent a file or other individual system object, such as a word processing document, that is executable alone, using an application, or using another system object. A stack item 560, 565 can represent a collection of related system objects, which can include stack elements, such as pictures, documents, or the like, that are associated with the stack item.

The viewing surface 502 further includes at least one desktop filter 505. According to an implementation, the desktop filter 505 can include a graphical user interface or panel that permits a user to interact with the desktop filter 505 to select one or more instructions that identify which system objects are displayed on the desktop environment 500, and the manner in which the system objects are displayed.

According to an implementation, the desktop filter 505 permits a user to modify the desktop environment 500 to display only system objects requested by the user for display. According to an implementation, the desktop environment modification can be temporary. Among other features, the desktop filter 505 provides a user with the ability to reduce system object clutter a desktop environment, and permits system object organization. According to an implementation, the desktop filter can not only apply to system objects displayed on the desktop environment 500, but all system objects capable of being displayed on the desktop environment 5000.

Although a single desktop filter is described herein with respect to the illustrative examples of FIGS. 5-14, two or more filters may be implemented. The two or more filters may also execute simultaneously. According to an implementation, a user may create or establish several filters, each of individually or in combination which may be applicable all of the time or part of the time. The applicability of each filter may be configured by a user and/or based on a user's actions. According to an implementation, a user-selected theme for a desktop environment may dictate the one or more filters that apply to a desktop environment.

As shown in FIG. 5, the desktop filter 505 can provide one or more user-selectable or configurable rules that modify the display of system objects on the desktop environment 500. According to an implementation, a user can toggle and/or select and/or configure one or more rules (also referred to herein as modification rules, or instructions) to identify one or more system objects or types of objects the user wishes to be displayed on the desktop environment, such as applications, folders, documents, stack items, and/or one or more visualization object receptacles. According to an implementation, identifying one or more system object types can cause the desktop filter to display on a desktop environment only the user-selected system object types. In the illustrative desktop environment 500 of FIG. 5, none of the user-selectable rules have been selected so that the desktop environment 500 displays all system objects 510, 515, 525, 530, 535, 540, 545, 550, 555, 560, 565.

According to another implementation, a user can select and/or configure one or more rules using the desktop filter 505 to display all recent system objects, or one or more subsets of recent system objects, including recent applications, recent folders, recent documents, and/or recent stack items. Recent system objects and their subsets can include those system objects that have been recently viewed, accessed, modified, deleted, and/or created, whether or not currently displayed in the desktop environment. The desktop filter 505 permits a user to identify rules for displaying only system objects satisfying a date or date range associated with a system object, including a date the system object was created, modified, viewed, and/or deleted.

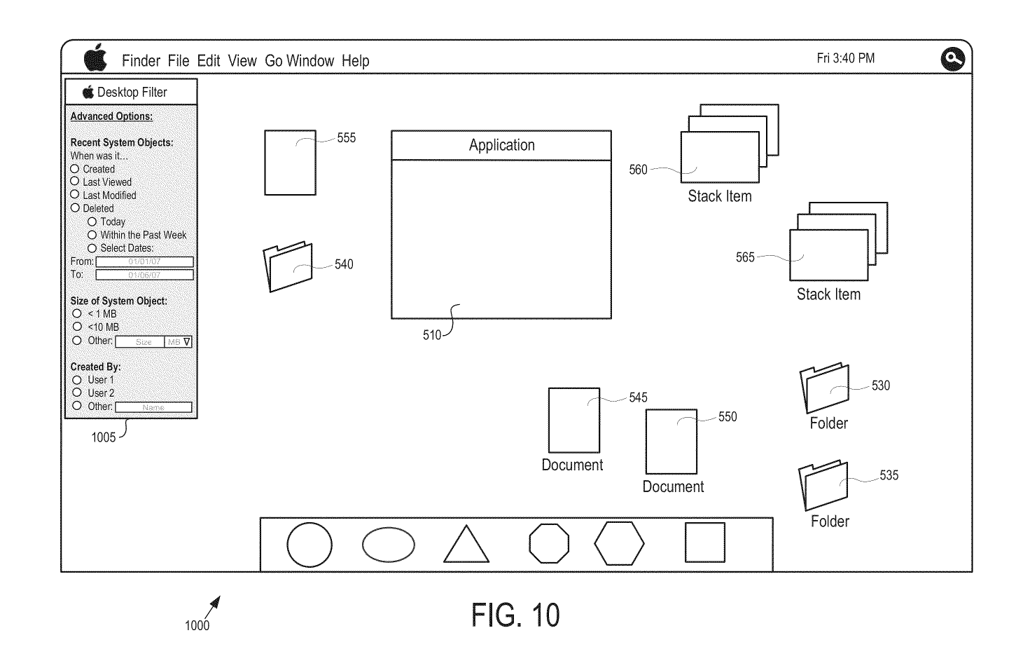

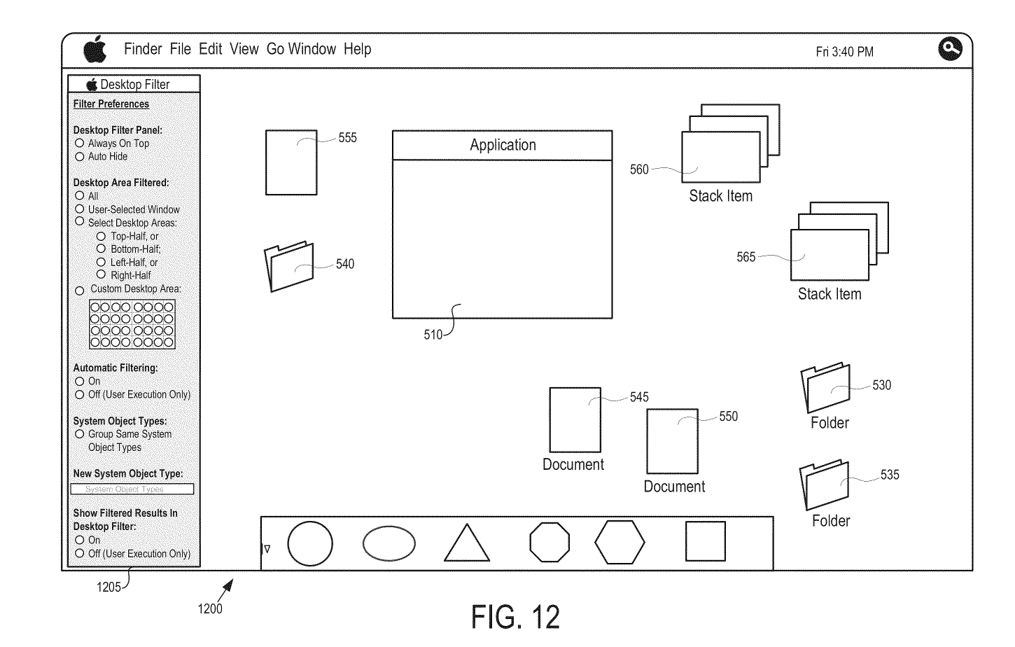

According to yet another implementation, a user can configure rules for displaying system objects of a particular size, and/or created by a particular person, as described with respect to FIG. 10. According to another implementation, the desktop filter 505 can also permit a user to configure additional desktop preferences (or rules) via a preferences selection on the desktop filter 505, as described with respect to FIG. 12. Among other features, the desktop preferences permit the user to control the applicability of desktop filter rules to system objects in a desktop environment.

According to an implementation, a desktop filter permits a user to identify one or more system objects and/or content types the user wishes to view. For instance, a user may identify that the user wishes to work on a particular type of object, such as photos. In this illustrative example, the filter may be operable to remove all system objects, other than photos, from the desktop environment.

The desktop filter 505 can be executed upon a user selection of an execute desktop filter selection, or the like, as shown in FIG. 5. Execution of the desktop filter 505 applies the one or more user-selectable rules to system objects, including those presented on the desktop environment 500 and/or other system objects that are capable of being presented and/or represented on the desktop environment 500. A user may also reset the desktop filter 505 using a reset filter selection, which can reset or eliminate all user-configured rules such that no filter is applied to a desktop environment 500. A user can also close the desktop filter and/or minimize the desktop filter 505 using one or more graphical user interface selections and/or features.

According to an implementation, the desktop filter 505 can execute automatically and/or continuously without a user selection of an execution button. According to an implementation, the desktop filter can implicitly execute based on behavior of a user. For instance, if a user is working only with a particular system object type, and/or with particular content for a period of time, the desktop filter may automatically filter the desktop environment to remove system objects and/or content unrelated to the system objects and/or content the user is working with. Automatic filtering may apply after a period of time, which may be configurable by a user.

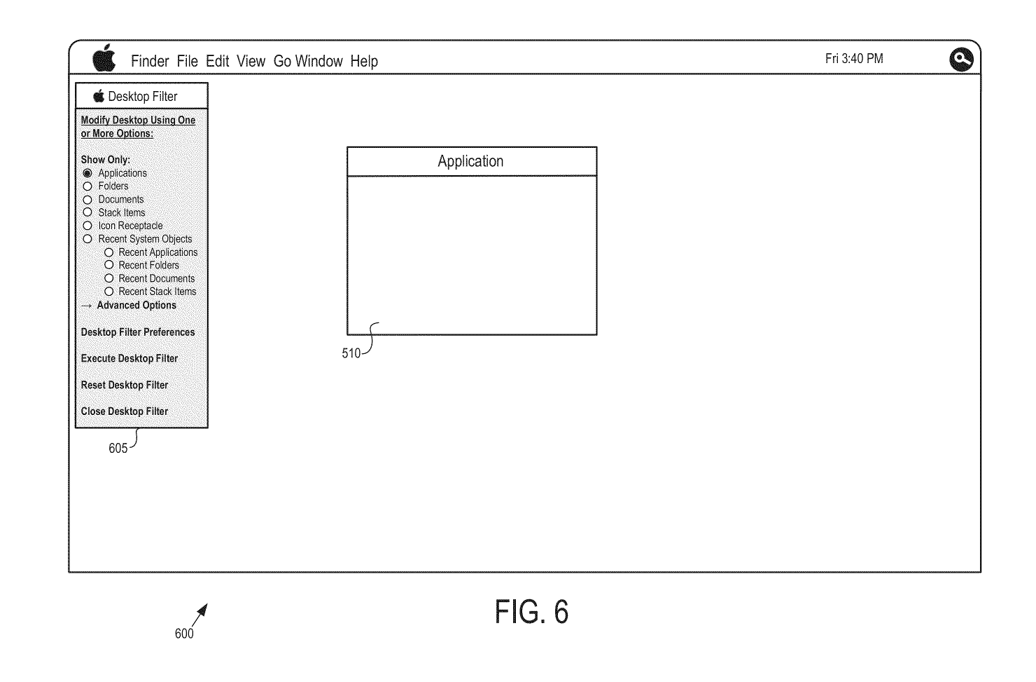

FIG. 6 is a block diagram of an example desktop environment 600 illustrating desktop filtering using a desktop filter 605. As shown in FIG. 6, one user-selectable rule, requesting that the desktop environment 600 display only applications, has been selected and applied to the desktop environment 500 of FIG. 5. A user can effect such a selection using a mouse or keyboard, for instance, to toggle the ‘Applications’ selection. Upon execution of the desktop filter 605, the desktop environment 600 displays only the system objects displayed on the desktop environment 500 that have a system object type that corresponds to the user-selected rule. Therefore, in the example implementation of FIG. 6, the application 510 is displayed on the desktop environment 600. All other system objects not satisfying the desktop filter rules are removed from the desktop environment 600.

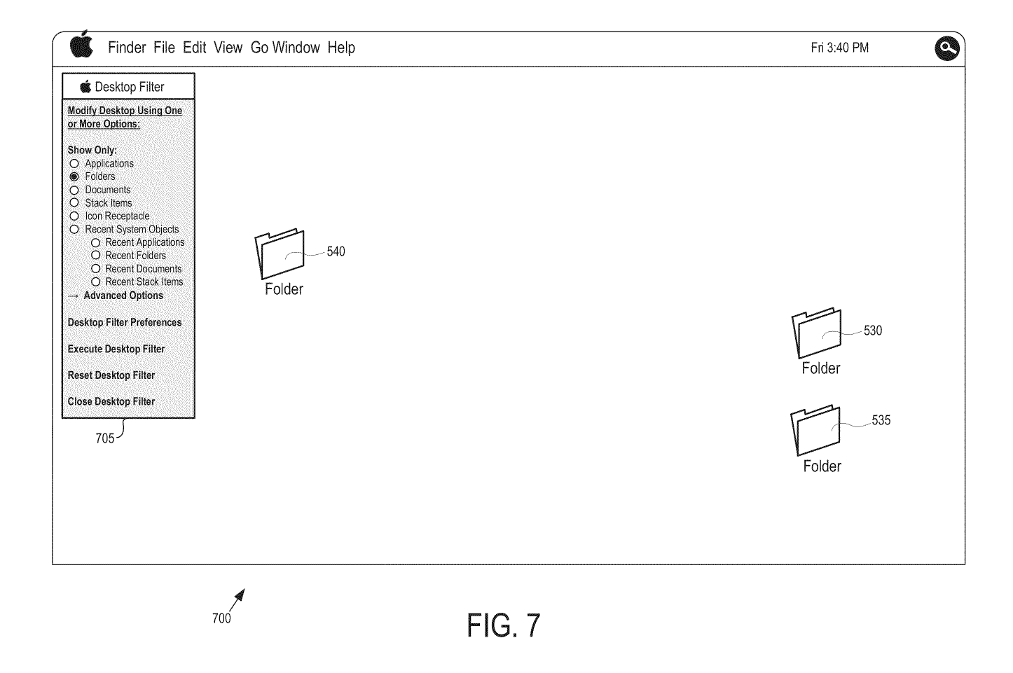

FIG. 7 is a block diagram of another example desktop environment 700 illustrating desktop filtering using a desktop filter 705. As shown in FIG. 7, one user-selectable rule, requesting that the desktop environment 700 display only folders, has been selected and applied to the desktop environment 500 of FIG. 5. As with the example described with respect to FIG. 6, a user can effect such a selection using an input device such as a mouse or keyboard, for instance, by toggling the ‘Folders’ selection. Upon execution of the desktop filter 705, the desktop environment 700 displays only those system objects having a ‘folder’ system object type that satisfies to the user-selected rule. Therefore, in the example implementation of FIG. 7, only folders 530, 535, 540 are displayed on the desktop environment 700 and all other system objects that are not a folder system object type are removed from the desktop environment 700.

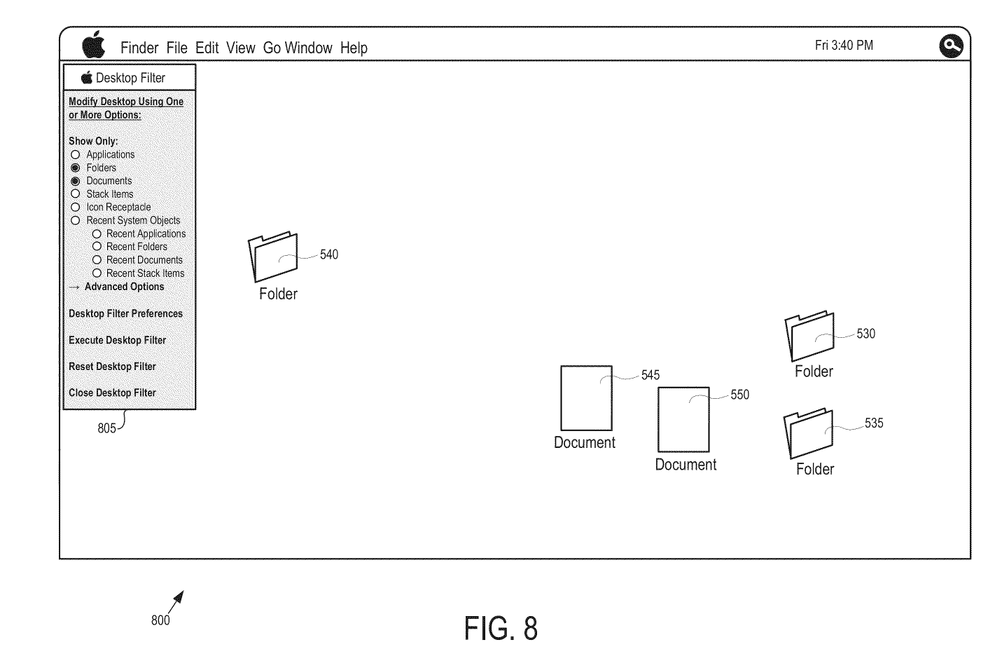

FIG. 8 is a block diagram of yet another example desktop environment 800 illustrating desktop filtering using a desktop filter 805. In FIG. 8, two user-selectable rules, requesting that the desktop environment 800 display folders and documents, have been selected and applied to the desktop environment 500 of FIG. 5. Therefore, upon execution of the desktop filter 805, the desktop environment 800 displays only folders 530, 535, 540 and documents 545, 550 in the desktop environment 800.

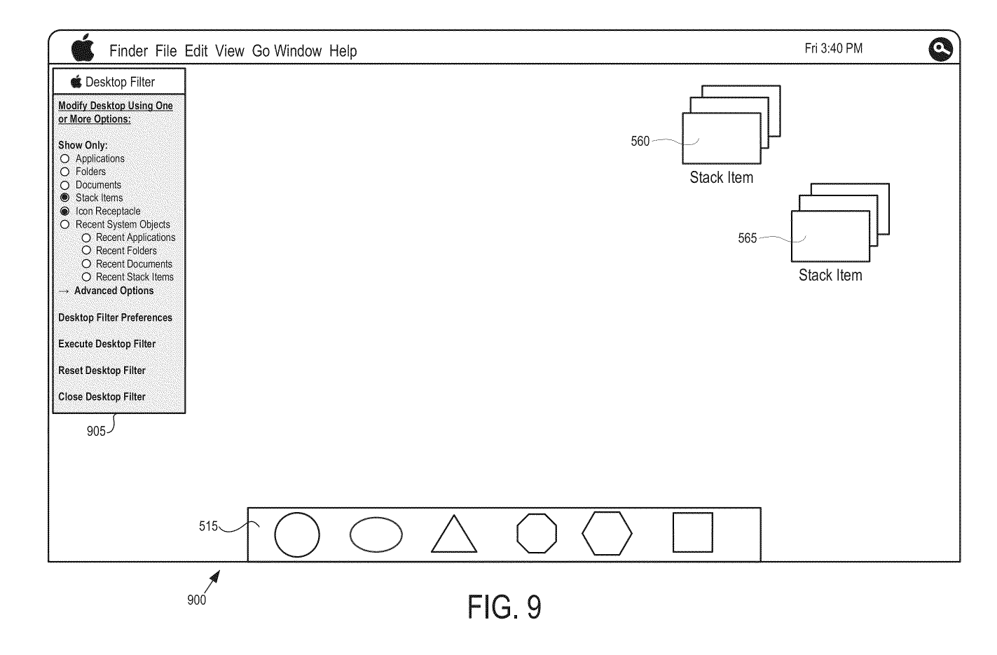

FIG. 9 is a block diagram of another example desktop environment 900 illustrating desktop filtering using a desktop filter 905. In FIG. 9, two user-selectable rules, requesting that the desktop environment 900 display stack items and the visualization object receptacle, have been selected. Therefore, upon execution of the desktop filter, the desktop environment 500 of FIG. 5 is modified to display only stack items 560, 565 and the visualization object receptacle 515 in the desktop environment 900.

FIG. 10 is a block diagram of another example desktop environment 1000 including a desktop filter 1005. According to an implementation, the desktop filter 1005 provides advanced options that may be configured and/or modified by a user to generate instructions to cause the desktop filter 1005 to display on the desktop environment 1000 only system objects associated with one or more dates, system objects of a particular size, and/or system object associated with a particular person, such as created by a particular person. According to an implementation, the advanced options provided by the desktop filter 1005 of FIG. 10 can be accessed via an advanced options desktop filter selection, for instance, as illustrated in the desktop filter 505 of FIG. 5.

According to an implementation, a user may instruct the desktop filter 1005 to display only those system objects that have been recently created, viewed, accessed, modified, and/or deleted by selecting one or more of these system object characteristics, such as via toggle selections. The user can also identify the dates of system object creation, viewing, accessing, modification, and/or deletion. According to an implementation, a user may be presented with one or more alternative choices for date identification, such as system objects created, viewed, accessed, modified, and/or deleted on today's date, within the past week, or the like. A user may also be presented with an interface to permit the user to input the date or a date range for system object creation, viewing, accessing, modification, and/or deletion.

According to other implementations, a user can identify the size of a system object and/or the identity of a user that has created and/or viewed a system object. The identity of known users corresponding to a device on which the desktop environment 1000 operates may be automatically identified, or the identity of users having creating the one or more system objects in a desktop environment may be identified automatically and provided as selectable rules in the desktop filter 1005. Similar to the identification of dates described above, a user can also identify the size of a system object and/or the identity of a user associated with a system object via one or more toggle selections provided by the desktop filter 1005 and/or via one or more input interfaces.

The desktop filter 1005 is operable to identify the one or more system objects that satisfy the user's date-specific requirements for system object creation, viewing, accessing, modification, and/or deletion, and/or the size of a system object, and/or the identify of a user associated with a system object, and can display only those system objects on the desktop environment 1000.

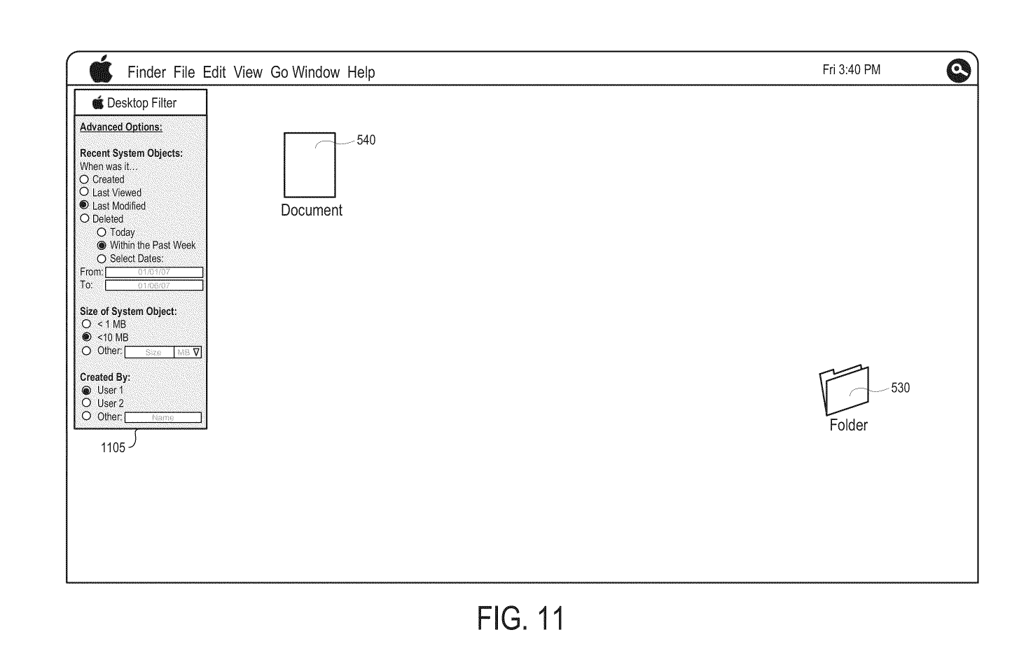

FIG. 11 is a block diagram of an example desktop environment 1100 illustrating desktop filtering using a desktop filter 1105. As shown in FIG. 11, several advanced user-selectable rules are configured by a user, requesting that the desktop environment 1000 of FIG. 10 be modified to display only system objects modified in the past week, having a size less than 10 MB, and created by User 1. Upon execution of the desktop filter, the desktop environment 1100 displays only those system objects satisfying the user-identified rules (i.e., instructions). In the example implementation of FIG. 11, a single document 540 and folders 530 are displayed on the desktop environment 1100 and all other system objects are removed from the desktop environment 1100.

FIG. 12 is a block diagram of another example desktop environment 1200 including a desktop filter 1205. According to an implementation, the desktop filter 1205 can permit a user to configure filter preferences (or rules) used by the desktop filter 1205 to effect modification of one or more system objects on a desktop environment. According to an implementation, the user-configurable filter preferences provided by the desktop filter 1205 can be accessed via a filter preferences selection, for instance, as provided in the desktop filter 505 of FIG. 5.

According to an implementation, the desktop preferences permit a user to configure whether the desktop panel 1205 remains in a viewable area of a desktop environment, such as displayed on the viewing surface 502. This may be configured by the user via one or more alternative toggle selections that instruct the desktop filter panel 1205 to remain always on top, i.e., visible, in a desktop environment, or to disappear (i.e., auto hide) after configuration is complete and an amount of time, such as a five seconds, has elapsed.

According to another implementation, the desktop preferences can permit a user to select the portion or portions of the desktop environment 500 that the desktop filter 505 will be applied against, such as the entire viewing surface 502 or only a portion thereof. The user may be presented with options to filter the entire desktop, to filter only system objects within a user-selected window, such as a window generated by a user's mouse selection of one or more system objects, the top-half or bottom-half of the desktop environment, and/or the left-half or right-half of the desktop environment, or one or more custom desktop areas. According to an implementation, the desktop filter 1205 can graphically present a user with one or more desktop environment regions that are selectable by the user to identify the one or more desktop environment regions against which the filter should be applied.

As an illustrative example, if the user selects a top-half toggle selection in the desktop filter 1205 of FIG. 5, only system objects displayed in the top-half of the desktop environment 500 may be modified. Additional preferences may be configurable by a user, such as rules identifying whether system objects must exist entirely within a selected area, only partially within a selected area, or that a certain percentage of an object must exist within a selected area, for the desktop filter rules to apply against a system object. According to another implementation, a user can disassociate one or more system objects from desktop filtering, for instance, by configuring the properties of a system object or by identifying the system object in a system object exception interface (not illustrated) in the desktop filter.

According to an implementation, while the desktop filter is active such that after a user has established one or more rules for modifying the desktop environment, the desktop filter 505 may modify the desktop environment automatically and/or continuously until a the desktop filter 505 is closed, reset, or disabled. This feature may be turned on or off by a user using for instance, toggle selections. If automatic filtering is turned off, the desktop filter will only apply the one or more rules to modify a desktop environment upon a user selection of an execute desktop filter selection, or the like, for instance, as is shown in FIG. 5.

According to another implementation, the desktop filter 1205 is operable to group system objects having the same object types. Therefore, the desktop filter may be configured to not only modify those system objects displayed in a desktop environment, but also the manner in which the system objects are displayed. For instance, the desktop filter may arrange system objects of the same object type together, such as adjacent each other, in a desktop environment. According to an implementation, the desktop filter can also modify the display of one or more stack elements by stacking the elements together as a stack item.

According to yet another implementation, the desktop filter can allow a user to customize the desktop filter 1205 by creating and/or identifying one or more system object types. This can occur via a pull-down menu of all system object types and/or via one or more other graphical user interfaces permitting a user to create a system object type the user may wish to associate with one or more system objects. Identification of a new system object type can automatically alter the desktop filter options. For instance, a new system object type may be automatically added to the desktop filter 505 of FIG. 5 to permit a user to toggle and/or select the new system object type, such that the new system object type is displayed with applications, folders, documents, stack items, and/or the visualization object receptacles options. The new system object may also be added to the recent system object selections.

According to still another implementation, a desktop filter can be configured by a user to display the system objects that satisfy one or more desktop rules, where the system objects satisfying the one or more desktop rules are displayed within the desktop filter or via a new window in a desktop environment. Therefore, instead of applying a filter against the desktop environment to modify, for instance, the system objects appearing on the two dimensional viewing surface 502, system objects in a desktop environment that satisfy desktop filter rules may be separately displayed to a user without impacting the system objects existing on the viewing surface prior to execution of the desktop filter. According to an implementation, one or more toggle selections or the like may be used to turn such a feature on or off.

A desktop filter may also execute based on recent actions a user has taken, rather than via instructions from a user. For instance, a filter may remove from the viewing surface system objects that are unrelated to system objects and/or content that a user that is working For instance, if a user is working on related files and/or applications for a period of time, the desktop filter may automatically remove unrelated system objects from the desktop environment. A user may also customize a filter such that similar objects are only displayed in a desktop environment. For instance, a “more like this” button may permit a user to only view system objects of a similar type and/or having similar content. As an example, if a user opens up a photo editor the desktop filter may only leave photos on the desktop, clearing other unrelated applications, such as word processing applications. According to another implementation, a user may select a particular file type, or content, and request that all similar files and/or content be displayed on the desktop environment by the desktop filter. Where a large number of results are identified, the desktop filter may automatically create one or more stacks of system objects. According to another implementation, desktop filtering may be based at least in part on metadata associated with system objects, including where the system object is stored, where it came from, who created it, when it was created, when it was last altered, content within the object, and the like.

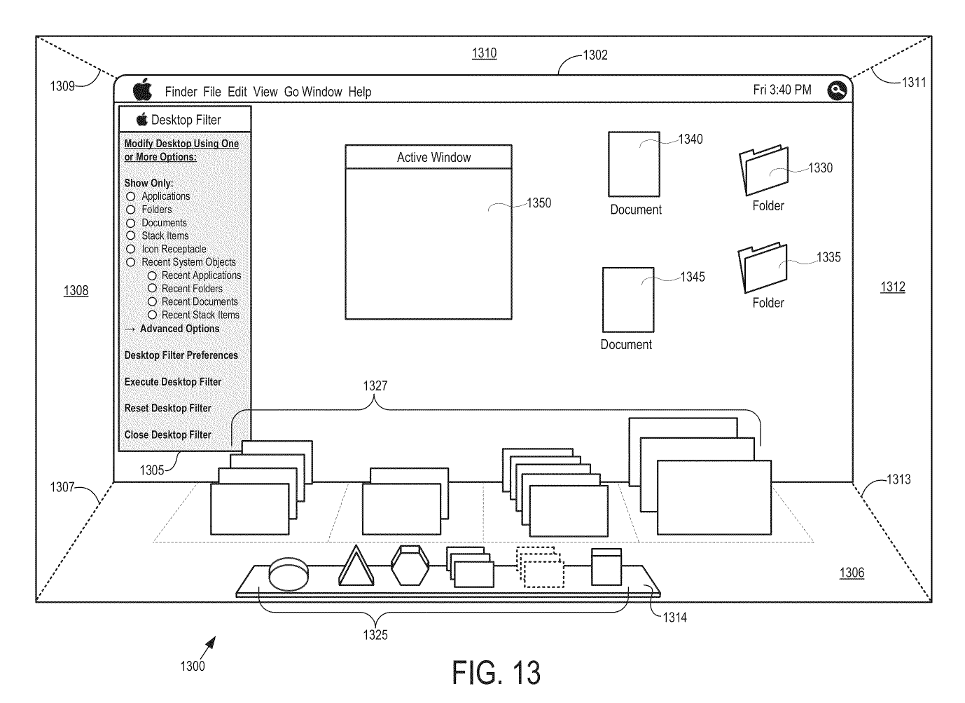

FIG. 13 is block diagram of an example multidimensional desktop environment 1300. In the example implementation, the multidimensional desktop environment 1300 includes a back surface 1302 that is axially disposed, e.g., along the z-axis, from a viewing surface 1304. In one implementation, the viewing surface can be defined by the entire image on a display device, e.g., a “front pane.” One or more side surfaces, such as side surfaces 1306, 1308, 1310 and 1312, are extended from the back surface to the viewing surface. A visualization object receptacle 1314 is generated on one or more of the side surfaces, such as side surface 1306. In an implementation, the side surfaces 1306, 1308, 1310 and 1312 can intersect at intersections 1307, 1309, 1311 and 1313, respectively. Although four side surfaces are shown in FIG. 13, few side surfaces can be defined; for example, in an implementation, only side surfaces 1306, 1308 and 1312 are defined, and there is an absence of a “top” side surface 1310.

The visualization object receptacle 1314 can include a plurality of visualization objects 1325. The visualization objects 1325 can, for example, include graphical representations corresponding to one or more system objects, such as applications, documents, and functions. Additionally, one or more system objects, e.g., stack items, visualization objects, and the like 1327, can be disposed on one or more of the side surfaces 1308, 1310 and 1312. In FIG. 13, the back surface 1302 of the example multidimensional desktop environment 1300 includes an active window 1350, two documents 1340, 1345, and two folders 1330, 1335.

The multidimensional desktop environment 1300 also includes a desktop filter 1305 similar to the desktop filter panel 505 described above with respect to FIG. 5. The desktop filter 1305 can also include advanced options similar to the desktop filter 1005 of FIG. 10, and filter preferences similar to the desktop filter 1205 of FIG. 12. Therefore, the filtering functions described for desktop filtering with respect to FIGS. 5-12 also apply to the multidimensional desktop environment 1300.

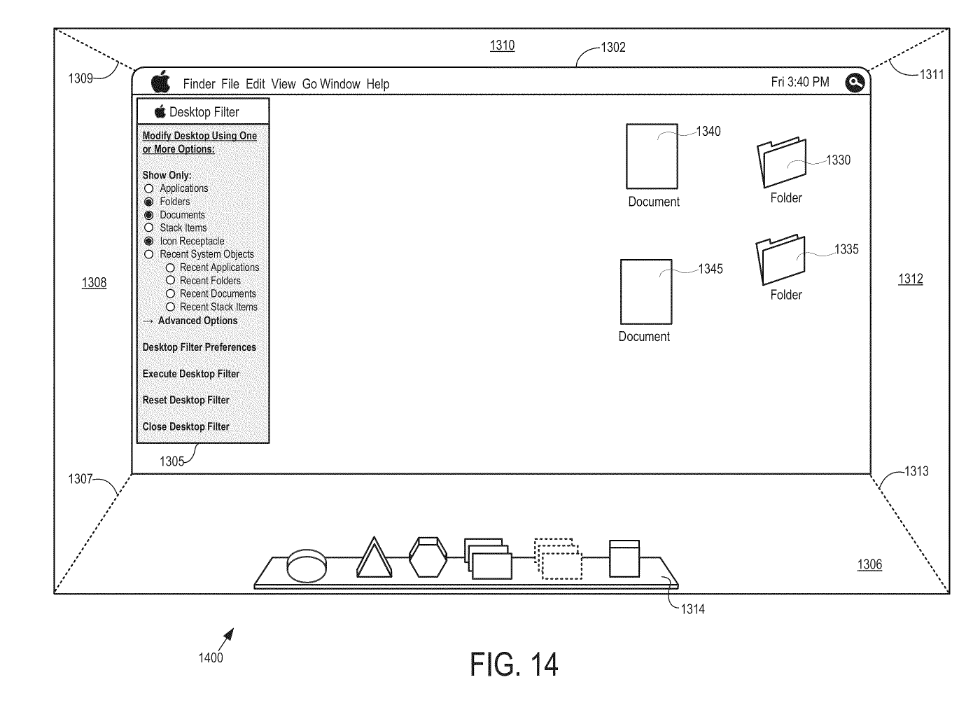

FIG. 14 shows a block diagram of an example multidimensional desktop environment 1400 illustrating desktop filtering using a desktop filter 1305. As shown in FIG. 14, three user-selectable rules, requesting that the desktop environment 1400 display only folders, documents, and the visualization object receptacle, have been selected and applied to the multidimensional desktop environment 1300 of FIG. 13. Upon execution of the desktop filter 1305, the desktop environment 1400 displays only the visualization object receptacle, and those system objects having a ‘folder’ or ‘document’ system object type that satisfy to the user-selected rule. Therefore, in the example implementation of FIG. 14, only folders 1330, 1335 and documents 1340, 1345 are displayed in the multidimensional desktop environment 1400 and all other system objects that are not a folder system object type do not appear in the multidimensional desktop environment 1400.

A multidimensional environment, such as the multidimensional desktop environment 1300 of FIG. 13, can permit user-configuration of additional desktop filter rules. For instance, according to an implementation, a user can configure whether the desktop filter 1305 graphical user interface or panel remains in a viewable area of a multidimensional desktop environment, and the viewing surface on which it is placed in a multidimensional desktop environment. According to an implementation, the graphical user interface or panel of the desktop filter may move to one of the side surfaces 1306, 1308, 1310 and 1312 after configuration of the rules are complete. Use of the desktop filter 1305 may cause the graphical user interface or panel of the desktop filter to transition or move to the back surface 1302 or viewing surface 1304.

According to another implementation, the desktop preferences can permit a user to select the portion or portions of a multidimensional desktop environment 1300 that the desktop filter 1305 will be applied against, such as all of the viewing surfaces or only a subset thereof, such as the back surface 1302 or viewing surface 1304. Additionally, a user may be presented with options to filter the entire desktop, to filter only individual surfaces of a multidimensional desktop, to filter only system objects within a user-selected window, or to filter one or more custom desktop areas.

According to still another implementation, a desktop filter 1305 can be configured by a user to display the system objects that satisfy one or more desktop rules, where the system objects satisfying the one or more desktop rules are displayed within the desktop filter, via a new window in a multidimensional desktop environment, or on one of the surfaces of a multidimensional environment, such as the side surfaces 1306, 1308, 1310 and 1312.

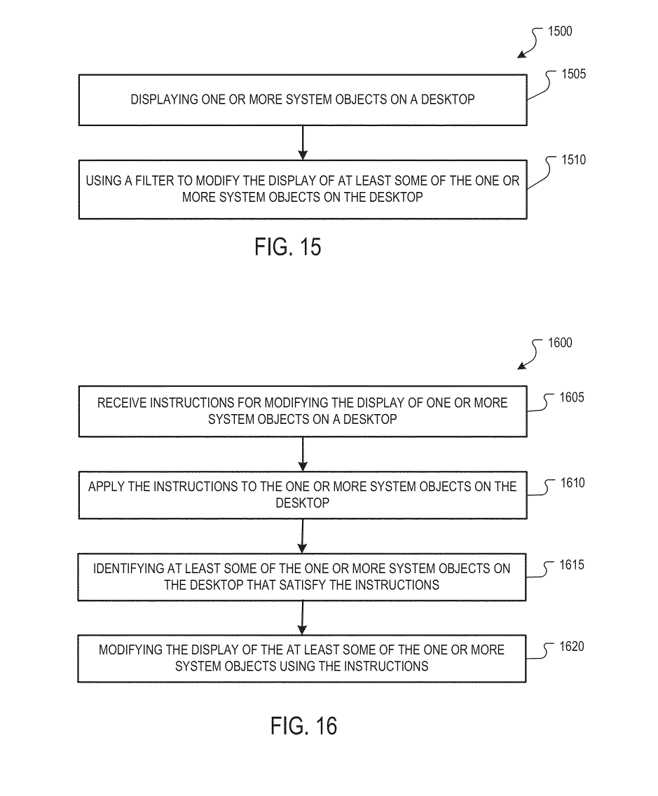

FIG. 15 is a flow diagram of an example process for modifying the display of one or more system objects on a desktop using a filter. First, one or more system objects are displayed on a desktop (block 1505). The desktop may comprise a desktop environment including a graphical user interface. According to an implementation, the desktop may be generated by the UI engine 202. Thereafter, a filter is used to modify the display of at least some of the one or more system objects on the desktop (block 1510). According to an implementation, the modification of the display of system objects on the desktop may be implemented by the UI engine using the desktop filter engine 307.

FIG. 16 is a flow diagram of an example process for using a filter to modifying the display of one or more system objects on a desktop. One or more instructions are received for modifying the display of one or more system objects on a desktop (block 1605). According to an implementation, the one or more instructions can include user-configurable rules input into a desktop filter via a graphical user interface that can include a desktop filter panel. The instructions are applied to the one or more system objects on a desktop (block 1610). According to an implementation, the process of applying the instructions against the system objects displayed on a desktop, which can include a desktop environment, can be performed by the desktop filter engine 307. At least some of the one or more system objects on the desktop that satisfy the instructions are identified (block 1615). Thereafter, the display of the at least some of the one or more system objects are modified using the instructions (block 1620). In an implementation, the desktop filter engine 307 is operable to apply one or more rules to a desktop, such as a desktop environment including a graphical user interface, to modify the display of one or more system objects on the desktop.

The desktop filter features described in the implementations are illustrative, and may be effected using one or more alternative graphical user interfaces. For instance, toggle selections may be used for user convenience, but are not required to receive user-configurable or user-selectable rules. Additionally, the desktop filter may exist as a floating panel, in a pull-down menu, or as a moveable window in the desktop environment. Although not illustrated, one or additional selections and/or graphical user interfaces may also exist in the desktop filter 1205 to permit a user to move in between various features of a desktop filter, such as between the desktop filter 505 of FIG. 5, the desktop filter 1005 of FIG. 10, and the desktop filter 1205 of FIG. 12. Still other implementations may exist.

The apparatus, methods, flow diagrams, and structure block diagrams described in this patent document may be implemented in computer processing systems including program code comprising program instructions that are executable by the computer processing system. Other implementations may also be used. Additionally, the flow diagrams and structure block diagrams described in this patent document, which describe particular methods and/or corresponding acts in support of steps and corresponding functions in support of disclosed structural means, may also be utilized to implement corresponding software structures and algorithms, and equivalents thereof.

1-53. (canceled)

54. A method comprising:
at a computer system with a display and one or more input devices:
displaying, on the display, a virtual desktop that includes a plurality of visual representations of objects at respective locations, wherein the plurality of visual representations of objects includes
a first set of one or more representations corresponding to objects that have a respective feature, and
a second set of one or more representations corresponding to objects that do not have the respective feature;
while displaying the first set of one or more representations and the second set of one or more representations, receiving, via the one or more input devices, a request to filter display of the plurality of visual representations of objects on the virtual desktop; and
in response to receiving the request to filter display of the plurality of visual representations, ceasing to display, on the display, the first set of one or more representations on the virtual desktop while maintaining display of the second set of one or more representations at the locations at which the second set of one or more representations were displayed prior to receiving the request to filter display of the plurality of visual representations of objects on the virtual desktop.

55. The method of claim 54, including after ceasing to display the first set of one or more representations:
receiving a request to remove the filter from the virtual desktop; and
in response to receiving the request to remove the filter from the virtual desktop, redisplaying, on the display, the first set of one or more representations on the virtual desktop at the locations at which the first set of one or more representations were displayed prior to receiving the request to filter display of the plurality of visual representations of objects on the virtual desktop.

56. The method of claim 55, wherein the first set of one or more representations is redisplayed while maintaining display of the second set of one or more representations at the locations at which the second set of one or more representations were displayed prior to receiving the request to filter display of the plurality of visual representations of objects on the virtual desktop.

57. The method of claim 54, wherein the first set of one or more representations includes a plurality of representations of objects and the second set of one or more representations includes a plurality of representations of objects.

58. The method of claim 54, wherein
the first set of one or more representations correspond to objects that have a first feature,
the second set of one or more representations correspond to objects that do not have the first feature,
the plurality of visual representations of objects includes
a third set of one or more representations correspond to objects that have a second feature, and
a fourth set of one or more representations correspond to objects that do not have the second feature, and
the method includes, in response to receiving the request to filter display of the plurality of visual representations,
in accordance with a determination that the request is a request to filter out representations of objects that have the first feature, ceasing to display, on the display, the first set of one or more representations on the virtual desktop while maintaining display of the second set of one or more representations at the locations at which the second set of one or more representations were displayed prior to receiving the request to filter display of the plurality of visual representations of objects on the virtual desktop, and
in accordance with a determination that the request is a request to filter out representations of objects that have the second feature, ceasing to display, on the display, the third set of one or more representations on the virtual desktop while maintaining display of the fourth set of one or more representations at the locations at which the fourth set of one or more representations were displayed prior to receiving the request to filter display of the plurality of visual representations of objects on the virtual desktop.

59. The method of claim 58, wherein the plurality of representations includes a representation of an object that has the first feature and the second feature.

60. The method of claim 58, wherein the plurality of representations includes a representation of an object that does not have the first feature and does not have the second feature.

61. The method of claim 58, wherein the plurality of representations includes a representation of an object that has the first feature and does not have the second feature.

62. The method of claim 58, wherein the plurality of representations includes a representation of an object that does not have the first feature and has the second feature.

63. The method of claim 54, wherein the feature of the objects includes one of an object type, an object size, or a date associated with an object.

64. A system comprising:
one or more hardware processors;
a display and one or more input devices communicatively coupled with the hardware processors; and
memory encoding instructions which, when executed by the hardware processors, cause the system to perform operations comprising:
displaying, on the display, a virtual desktop that includes a plurality of visual representations of objects at respective locations, wherein the plurality of visual representations of objects includes
a first set of one or more representations corresponding to objects that have a respective feature, and
a second set of one or more representations corresponding to objects that do not have the respective feature;
while displaying the first set of one or more representations and the second set of one or more representations, receiving, via the one or more input devices, a request to filter display of the plurality of visual representations of objects on the virtual desktop; and
in response to receiving the request to filter display of the plurality of visual representations, ceasing to display, on the display, the first set of one or more representations on the virtual desktop while maintaining display of the second set of one or more representations at the locations at which the second set of one or more representations were displayed prior to receiving the request to filter display of the plurality of visual representations of objects on the virtual desktop.

65. The system of claim 64, wherein the operations comprise after ceasing to display the first set of one or more representations:
receiving a request to remove the filter from the virtual desktop; and
in response to receiving the request to remove the filter from the virtual desktop, redisplaying, on the display, the first set of one or more representations on the virtual desktop at the locations at which the first set of one or more representations were displayed prior to receiving the request to filter display of the plurality of visual representations of objects on the virtual desktop.

66. The system of claim 65, wherein the first set of one or more representations is redisplayed while maintaining display of the second set of one or more representations at the locations at which the second set of one or more representations were displayed prior to receiving the request to filter display of the plurality of visual representations of objects on the virtual desktop.

67. The system of claim 64, wherein the first set of one or more representations includes a plurality of representations of objects and the second set of one or more representations includes a plurality of representations of objects.

68. The system of claim 64, wherein
the first set of one or more representations correspond to objects that have a first feature,
the second set of one or more representations correspond to objects that do not have the first feature,
the plurality of visual representations of objects includes
a third set of one or more representations correspond to objects that have a second feature, and
a fourth set of one or more representations correspond to objects that do not have the second feature, and
the operations comprise, in response to receiving the request to filter display of the plurality of visual representations,
in accordance with a determination that the request is a request to filter out representations of objects that have the first feature, ceasing to display, on the display, the first set of one or more representations on the virtual desktop while maintaining display of the second set of one or more representations at the locations at which the second set of one or more representations were displayed prior to receiving the request to filter display of the plurality of visual representations of objects on the virtual desktop, and
in accordance with a determination that the request is a request to filter out representations of objects that have the second feature, ceasing to display, on the display, the third set of one or more representations on the virtual desktop while maintaining display of the fourth set of one or more representations at the locations at which the fourth set of one or more representations were displayed prior to receiving the request to filter display of the plurality of visual representations of objects on the virtual desktop.

69. The system of claim 68, wherein the plurality of representations includes a representation of an object that has the first feature and the second feature.

70. The system of claim 68, wherein the plurality of representations includes a representation of an object that does not have the first feature and does not have the second feature.

71. The system of claim 68, wherein the plurality of representations includes a representation of an object that has the first feature and does not have the second feature.

72. The system of claim 68, wherein the plurality of representations includes a representation of an object that does not have the first feature and has the second feature.

73. The system of claim 64, wherein the feature of the objects includes one of an object type, an object size, or a date associated with an object.

74. A non-transitory computer readable storage medium encoding instructions which, when executed by data processing apparatus, cause the data processing apparatus to perform operations comprising:
displaying, on a display associated with the data processing apparatus, a virtual desktop that includes a plurality of visual representations of objects at respective locations, wherein the plurality of visual representations of objects includes
a first set of one or more representations corresponding to objects that have a respective feature, and
a second set of one or more representations corresponding to objects that do not have the respective feature;
while displaying the first set of one or more representations and the second set of one or more representations, receiving, via one or more input devices associated with the data processing apparatus, a request to filter display of the plurality of visual representations of objects on the virtual desktop; and
in response to receiving the request to filter display of the plurality of visual representations, ceasing to display, on the display, the first set of one or more representations on the virtual desktop while maintaining display of the second set of one or more representations at the locations at which the second set of one or more representations were displayed prior to receiving the request to filter display of the plurality of visual representations of objects on the virtual desktop.

75. The non-transitory computer readable storage medium of claim 74, wherein the operations comprise after ceasing to display the first set of one or more representations:
receiving a request to remove the filter from the virtual desktop; and
in response to receiving the request to remove the filter from the virtual desktop, redisplaying, on the display, the first set of one or more representations on the virtual desktop at the locations at which the first set of one or more representations were displayed prior to receiving the request to filter display of the plurality of visual representations of objects on the virtual desktop.

76. The non-transitory computer readable storage medium of claim 75, wherein the first set of one or more representations is redisplayed while maintaining display of the second set of one or more representations at the locations at which the second set of one or more representations were displayed prior to receiving the request to filter display of the plurality of visual representations of objects on the virtual desktop.

77. The non-transitory computer readable storage medium of claim 74, wherein the first set of one or more representations includes a plurality of representations of objects and the second set of one or more representations includes a plurality of representations of objects.

78. The non-transitory computer readable storage medium of claim 74, wherein
the first set of one or more representations correspond to objects that have a first feature,
the second set of one or more representations correspond to objects that do not have the first feature,
the plurality of visual representations of objects includes
a third set of one or more representations correspond to objects that have a second feature, and
a fourth set of one or more representations correspond to objects that do not have the second feature, and
the operations comprise, in response to receiving the request to filter display of the plurality of visual representations,
in accordance with a determination that the request is a request to filter out representations of objects that have the first feature, ceasing to display, on the display, the first set of one or more representations on the virtual desktop while maintaining display of the second set of one or more representations at the locations at which the second set of one or more representations were displayed prior to receiving the request to filter display of the plurality of visual representations of objects on the virtual desktop, and
in accordance with a determination that the request is a request to filter out representations of objects that have the second feature, ceasing to display, on the display, the third set of one or more representations on the virtual desktop while maintaining display of the fourth set of one or more representations at the locations at which the fourth set of one or more representations were displayed prior to receiving the request to filter display of the plurality of visual representations of objects on the virtual desktop.

79. The non-transitory computer readable storage medium of claim 78, wherein the plurality of representations includes a representation of an object that has the first feature and the second feature.

80. The non-transitory computer readable storage medium of claim 78, wherein the plurality of representations includes a representation of an object that does not have the first feature and does not have the second feature.

81. The non-transitory computer readable storage medium of claim 78, wherein the plurality of representations includes a representation of an object that has the first feature and does not have the second feature.

82. The non-transitory computer readable storage medium of claim 78, wherein the plurality of representations includes a representation of an object that does not have the first feature and has the second feature.

83. The non-transitory computer readable storage medium of claim 74, wherein the feature of the objects includes one of an object type, an object size, or a date associated with an object.
